(19) United States
(12) Patent Application Publication
(10) Pub. No.: US 2021/0146827 A1
(43) Pub. Date: May 20, 2021

(54) SYSTEMS AND METHODS TO COMMUNICATE AN INTENDED VEHICLE MANEUVER

(71) Applicant: GM GLOBAL TECHNOLOGY OPERATIONS LLC, Detroit, MI (US)

(72) Inventors: Lawrence A. Bush, Shelby Township, MI (US); Zachariah E. Tyree, Shelby Charter Twp., MI (US); Prabhjot Kaur, Troy, MI (US); Upali P. Mudalige, Oakland Twp., MI (US)

(73) Assignee: GM GLOBAL TECHNOLOGY OPERATIONS LLC, Detroit, MI (US)

(21) Appl. No.: 16/689,780

(22) Filed: Nov. 20, 2019

(51) Int. Cl. B60Q 1/30; B60Q 1/26; B60W 30/18; G05D 1/02; G05D 1/00; G07C 5/00; G06K 9/00

(52) U.S. Cl. CPC B60Q 1/302; B60Q 1/2603; B60W 30/18109; G06K 9/00818; G05D 1/0088; G07C 5/008; G05D 1/0282

(57) ABSTRACT

An exemplary automotive vehicle includes a first actuator configured to control acceleration and braking of the automotive vehicle, a second actuator configured to control steering of the automotive vehicle, a vehicle sensor configured to generate data regarding the presence, location, classification, and path of detected features in a vicinity of the automotive vehicle and a controller in communication with the vehicle sensor, and the first and second actuators. The controller is configured to selectively control the first and second actuators in an autonomous mode along a first trajectory according to an automated driving system. The controller is also configured to receive the data regarding the detected features from the vehicle sensor, determine a predicted vehicle maneuver from the data regarding the detected features, map the predicted vehicle maneuver with an indication symbol, and generate a control signal to display the indication symbol.

The present disclosure relates generally to systems and methods for conveying the intended maneuvers of vehicles controlled by automated driving systems, such as, for example, vehicle steering, acceleration, and braking, to operator-controlled vehicles.

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Typically, current methods and systems for conveying vehicle intent is limited to indicators such as brake lights or messages that may be overly complicated or confusing to the operators of surrounding vehicles due to the time needed for interpretation of such messages. Methods and systems such as those discussed herein are used to more clearly and concisely convey the intended, or projected, maneuver of an autonomous, semi-autonomous, or operator-controlled vehicle to surrounding operator-controlled vehicles.

### SUMMARY

Embodiments according to the present disclosure provide a number of advantages. For example, embodiments according to the present disclosure convey a message regarding an intended maneuver of an autonomous or semi-autonomous vehicle using conventional traffic symbols or signs.

In one aspect of the present disclosure, a system for conveying an intended vehicle maneuver includes an intention display system including a controller configured to receive data regarding the presence, location, classification, and path of detected features in a vicinity of an automotive vehicle, determine the intended vehicle maneuver from the data regarding the detected features, map the intended vehicle maneuver to an indication symbol, and generate a control signal to display the indication symbol and a vehicle component of the automotive vehicle configured to display the indication symbol.

In some aspects, the indication symbol is a traffic sign.

In some aspects, the traffic sign includes one or more of the signs recognized by the Vienna Convention on Road Signs and Signals.

In some aspects, the vehicle component is a rear windshield of a vehicle.

In some aspects, the vehicle component is a brake/signal light system of a vehicle.

In some aspects, the system further includes a wireless communication system in electronic communication with the controller. The wireless communication system is configured to receive vehicle maneuver and indication symbol mapping data from a remote access center.

In some aspects, the system further includes a projection system configured to project the indication symbol of the intended vehicle maneuver on the vehicle component, wherein the vehicle component is a rear windshield.

In some aspects, the indication symbol includes a first indication symbol and a second indication symbol, and the first indication symbol is different from the second indication symbol.

In some aspects, the system further includes a projection system configured to project the first and second indication symbols on a rear windshield of the automotive vehicle, wherein the first and second indication symbols are projected next to each other.

In some aspects, the vehicle component includes a first brake/signal light system and a second brake/signal light system, and wherein the first indication symbol is displayed on the first brake signal light system and the second indication symbol is displayed on the second brake/signal light system.

In another aspect of the present disclosure, an automotive vehicle includes a wireless communication system configured to transmit and receive vehicle data, a first actuator configured to control acceleration and braking of the automotive vehicle, a second actuator configured to control steering of the automotive vehicle, a vehicle sensor configured to generate data regarding the presence, location, classification, and path of detected features in a vicinity of the automotive vehicle, and a controller in communication with the vehicle sensor, the first and second actuators, and the wireless communication system, the controller configured to selectively control the first and second actuators in an autonomous mode along a first trajectory according to an automated driving system. The controller is also configured to receive the data from the vehicle sensor regarding the presence, location, classification, and path of detected features in a vicinity of the automotive vehicle, determine a predicted vehicle maneuver from the data regarding the detected features, map the predicted vehicle maneuver with an indication symbol, and generate a control signal to display the indication symbol.

In some aspects, the indication symbol is a traffic sign.

In some aspects, the traffic sign includes one or more of the signs recognized by the Vienna Convention on Road Signs and Signals.

In some aspects, the automotive vehicle further includes a windshield configured to display the indication symbol.

In some aspects, the automotive vehicle further includes a brake/signal light system configured to display the indication symbol.

In some aspects, the wireless communication system is configured to receive vehicle maneuver and indication symbol mapping data from a remote access center.

In some aspects, the automotive vehicle further includes a vehicle component and a projection system in communication with the controller, the projection system configured to project the indication symbol of the intended vehicle maneuver on the vehicle component, wherein the vehicle component is a rear windshield.

In some aspects, the indication symbol includes a first indication symbol and a second indication symbol, and the projection system is configured to project the first and second indication symbols next to each other on the rear windshield of the automotive vehicle.

In some aspects, the automotive vehicle further includes a first brake/signal light system and a second brake/signal light system and the indication symbol includes a first indication symbol and a second indication symbol such that the first indication symbol is displayed on the first brake signal light system and the second indication symbol is displayed on the second brake/signal light system.

In yet another aspect of the present disclosure, a method for communicating an intended vehicle maneuver includes receiving, by a controller, data regarding the presence, location, classification, and path of detected features in a vicinity of the automotive vehicle, determining, by the controller, the intended vehicle maneuver from the data regarding the detected features, mapping, by the controller, the intended vehicle maneuver with one or more indication symbols, the mapping including evaluating a data set including a description of the intended vehicle maneuver, wherein the description corresponds to one or more indication symbols and generating, by the controller, a control signal to display the one or more indication symbols.

### BRIEF DESCRIPTION OF THE DRAWINGS

The present disclosure will be described in conjunction with the following figures, wherein like numerals denote like elements.

FIG. 1 is a schematic diagram of a vehicle, according to an embodiment of the present disclosure.

FIG. 2 is a schematic diagram of a communication system including an autonomously controlled vehicle, according to an embodiment of the present disclosure.

FIG. 3 is a schematic diagram of a vehicle including an intention display system, according to an embodiment of the present disclosure.

FIG. 4 is a schematic diagram of a vehicle including an intention display system configured to display an intention in a brake/signal light system of the vehicle, according to an embodiment of the present disclosure.

FIG. 5A is an illustration of a vehicle intention display situational example, according to an embodiment of the present disclosure.

FIG. 5B is a schematic illustration of a vehicle conveying an intended maneuver for the situation shown in FIG. 5A, according to an embodiment of the disclosure.

FIG. 6A is an illustration of a vehicle intention display situational example, according to an embodiment of the present disclosure.

FIG. 6B is a schematic illustration of a vehicle conveying an intended maneuver for the situation shown in FIG. 6A, according to an embodiment of the disclosure.

FIG. 7A is an illustration of a vehicle intention display situational example, according to an embodiment of the present disclosure.

FIG. 7B is a schematic illustration of a vehicle conveying an intended maneuver for the situation shown in FIG. 7A, according to an embodiment of the disclosure.

FIG. 8 is a flowchart of a method for conveying an intended or projected vehicle maneuver, according to an embodiment of the disclosure.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above derivatives thereof, and words of similar import.

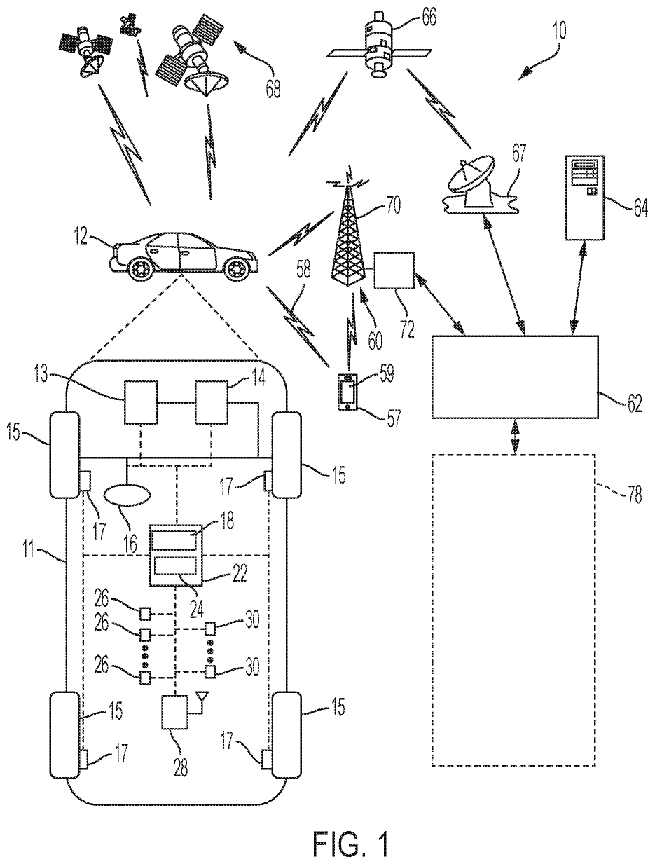

FIG. 1 schematically illustrates an operating environment that includes a mobile vehicle communication and control system 10 for an automotive vehicle 12. The communication and control system 10 for the vehicle 12 generally includes one or more wireless carrier systems 60, a land communications network 62, a computer 64, a mobile device 57 such as a smart phone, and a remote access center 78.

The vehicle 12 is depicted in the illustrated embodiment as a passenger car, but it should be appreciated that any other vehicle, including motorcycles, trucks, sport utility vehicles (SUVs), or recreational vehicles (RVs), etc., can also be used. The vehicle 12 includes a propulsion system 13, which may in various embodiments include an internal combustion engine, an electric machine such as a traction motor, and/or a fuel cell propulsion system.

The vehicle 12 generally includes a body 11 and wheels 15. The body 11 encloses the other components of the vehicle 12 and also defines a passenger compartment. The wheels 15 are each rotationally coupled to the body 11 near a respective corner of the body 11.

The vehicle 12 also includes a transmission 14 configured to transmit power from the propulsion system 13 to the plurality of vehicle wheels 15 according to selectable speed ratios. According to various embodiments, the transmission 14 may include a step-ratio automatic transmission, a continuously variable transmission, or other appropriate transmission.

The vehicle 12 additionally includes a steering system 16. While depicted as including a steering wheel for illustrative purposes, in some embodiments contemplated within the scope of the present disclosure, the steering system 16 may not include a steering wheel.

The vehicle 12 additionally includes a braking system including wheel brakes 17 configured to provide braking torque to the vehicle wheels 15. The wheel brakes 17 may, in various embodiments, include friction brakes, a regenerative braking system such as an electric machine, and/or other appropriate braking systems.

In various embodiments, the vehicle 12 also includes a wireless communication system 28 configured to wirelessly communicate with any wireless communication equipped device (vehicle-to-everything or “V2X”), including other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, wireless communications systems configured to communicate via additional or alternate wireless communications standards, such as IEEE 802.11 and cellular data communication, are also considered within the scope of the present disclosure.

The propulsion system 13, transmission 14, steering system 16, and wireless communication system 28 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

In various embodiments, the controller 22 includes an automated driving system (ADS) 24 for automatically controlling various actuators in the vehicle. In an exemplary embodiment, the ADS 24 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate to capture vehicle characteristic or operating conditions including, for example and without limitation, vehicle speed, acceleration, and steering wheel angle.

Some embodiments include an intention display system 18. The intention display system 18 includes, in various embodiments, a projector or projection system to project an indication of an intended vehicle maneuver on a rear and/or front windshield of the vehicle 12. In various embodiments, the intention display system 18 is also configured to display a sign or other indication of an intended vehicle maneuver on a brake/signal light of the vehicle 12, as discussed in greater detail herein. The intention display system 18 is electronically connected to, or incorporated into, the controller 22.

FIG. 1 illustrates several networked devices that can communicate with the wireless communication system 28 of the vehicle 12. One of the networked devices that can communicate with the vehicle 12 via the wireless communication system 28 is the mobile device 57. The mobile device 57 can include computer processing capability, a transceiver capable of communicating using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving GPS satellite signals and generating GPS coordinates based on those signals. In other embodiments, the mobile device 57 includes cellular communications functionality such that the mobile device 57 carries out voice and/or data communications over the wireless carrier system 60 using one or more cellular communications protocols, as are discussed herein. The visual smart phone display 59 may also include a touch-screen graphical user interface.

The wireless carrier system 60 is preferably a cellular telephone system that includes a plurality of cell towers 70 (only one shown), one or more mobile switching centers (MSCs), as well as any other networking components required to connect the wireless carrier system 60 with the land communications network 62. Each cell tower 70 includes sending and receiving antennas and a base station, with the base stations from different cell towers being connected to the MSC either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower /base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide uni-directional or bi-directional communication with the vehicle 12. This can be done using one or more communication satellites 66 and an uplink transmitting station 67. Uni-directional communication can include, for example, satellite radio services, wherein programming content (news, music, etc.) is received by the transmitting station 67, packaged for upload, and then sent to the satellite 66, which broadcasts the programming to subscribers. Bi-directional communication can include, for example, satellite telephony services using the satellite 66 to relay telephone communications between the vehicle 12 and the station 67. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62 but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the vehicle 12 via the wireless communication system 28 and the wireless carrier system 60. Other computers 64 can include, for example: a service center computer where diagnostic information and other vehicle data can be uploaded from the vehicle via the wireless communication system 28 or a third party repository to or from which vehicle data or other information is provided, whether by communicating with the vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the vehicle 12. The computer 64 may be in communication with at least one supplemental vehicle in addition to the vehicle 12. The vehicle 12 and any supplemental vehicles may be collectively referred to as a fleet.

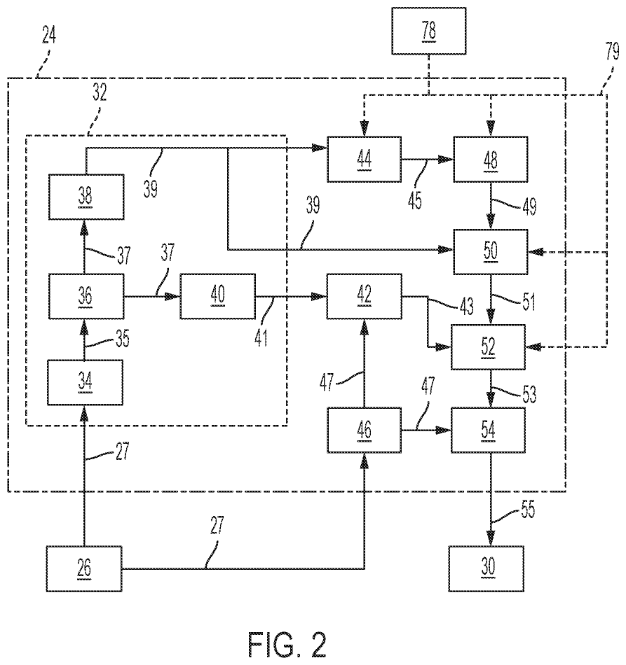

As shown in FIG. 2, the ADS 24 includes multiple distinct control systems, including at least a perception system 32 for determining the presence, location, classification, and path of detected features or objects in the vicinity of the vehicle. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light classification, object segmentation, ground segmentation, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in an urban environment, such as, for example, manhole covers, bridges, overhead trees or light poles, and other obstacles with a high RADAR cross section but which do not affect the ability of the vehicle to travel along its path. Additional object classification and tracking processes performed by the classification and segmentation module 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the vehicle 12 during operation and mapping data “pushed” to the vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an online database or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

Typically, vehicles, whether autonomous or semi-autonomous, do not have a way to clearly convey to surrounding vehicles an intended or projected maneuver, other than the traditional methods of signal lights. The systems and methods discussed herein more clearly and concisely convey the intended, or projected, maneuver of an autonomous, semi-autonomous, or operator-controlled vehicle to surrounding operator-controlled vehicles, allowing the operators to quickly interpret and respond to the projected maneuver of the autonomous or semi-autonomous vehicle.

In the various embodiments discussed, herein, indication symbols, such as, for example and without limitation, stop signs, merge signs, slow signs, pedestrian crossing signs, caution signs, speed indication signs, right/left turn signs, etc. are displayed by an autonomous or semi-autonomous vehicle in such a way that the traffic sign or symbol is visible to the operators of surrounding vehicles. Traffic signs offer a natural way of encoding the salient features of autonomous or semi-autonomous vehicle intent as vehicle operators are already familiar with the semantics encoded in these signs. Furthermore, traffic signs and conventions have been largely standardized by the Vienna Convention of Road Signs and Signals (1968).

In various embodiments, the vehicle control output 55 is also communicated to the intention display system 18. From the vehicle control output 55, the intention display system 18 determines whether an indicator, such as a sign, should be displayed on the vehicle 12 in view of surrounding vehicles, to convey an intended maneuver of the vehicle 12. In various embodiments, the intention display system 18 receives indicator data and display instructions from the remote access center 78 discussed herein.

As discussed in greater detail herein, the indicator can include symbols or signs commonly understood by vehicle operators to indicate various driving conditions, such as pedestrian crosswalks, merge areas, yielding behavior, slowing or stopping behavior, wide turns, etc., for example and without limitation. In various embodiments, the indicator can be tailored to the local conditions, for example, to include the local language or other local sign conventions. In various embodiments, the indicator data is accessed from an online or locally stored database.

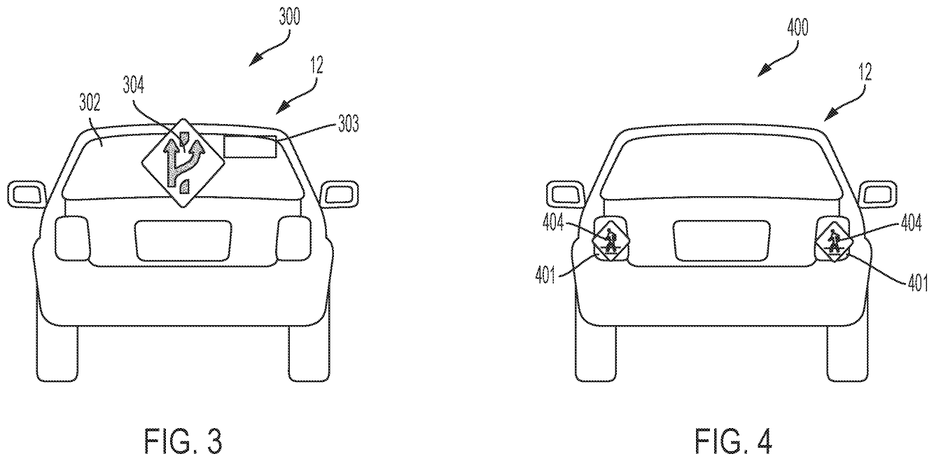

FIG. 3 is a schematic illustration of a notification system 300 for conveying an intended, or projected, maneuver of the vehicle 12, according to an embodiment. The system 300 includes a windshield 302 of the vehicle 12 that in various embodiments is the rear window of the vehicle 12. The windshield 302 is configured to display an indication symbol 304, such as a traffic sign, for example, one of the signs identified and codified by the Vienna Convention on Road Signs and Signals. In various embodiments, the windshield 302 includes technology capable of displaying the indication symbol 304 projected from a projector or projection system 303 of the vehicle 12. In various embodiments, the projection system 303 is in electronic communication with the controller 22 and the intention display system 18.

Another embodiment of a notification system 400 for conveying an intended, or projected, maneuver of the vehicle 12 is shown in FIG. 4. The system 400 includes brake/signal light systems 401 that are configured to display an indication symbol 404. Similar to the indication symbol 304, the indication symbol 404 is one of the signs identified and codified by the Vienna Convention on Road Signs and Signals. In various embodiments, each brake/signal light system 401 displays the same indication symbol 404; however, in other embodiments, each brake/signal light system 401 displays a different indication symbol 404. In various embodiments, the indication symbol 404 messages can be digitally integrated into the brake/signal light systems 401. In various embodiments, the notification system 400 is in electronic communication with the controller 22 and the intention display system 18.

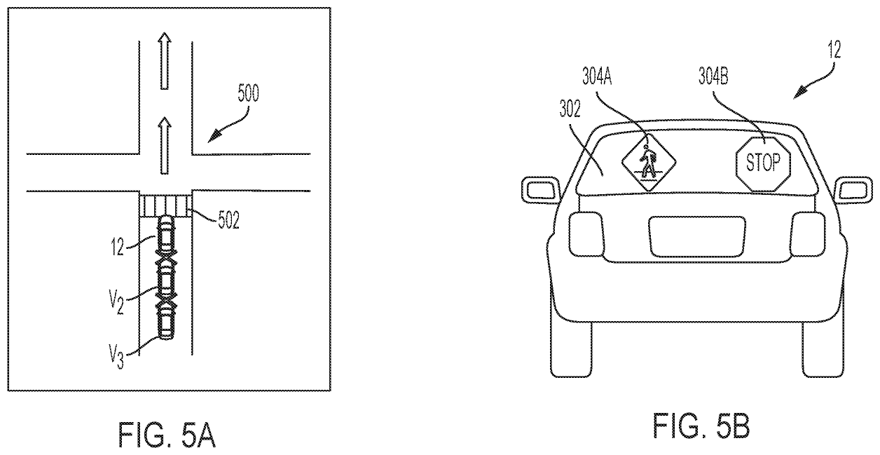

Several situational example cases are schematically illustrated in FIGS. 5-7. As shown in FIG. 5A, an autonomous or semi-autonomous vehicle, such as the vehicle 12, approaches an intersection 500. The intersection 500 includes a crosswalk 502. One or more vehicles, such as the vehicles V2 and V3, are in the vicinity of the vehicle 12, such as following behind the vehicle 12. The vehicles V2, V3 may be operator-controlled vehicles and the vehicle operators may not know the traffic flow at the intersection 500 or may not be able to predict the behavior of the vehicle 12.

As shown in FIG. 5B, the windshield 302 of the vehicle 12 includes technology capable of displaying one or more indication symbols, such as the indication symbols 304A, 304B. The indication symbols 304A, 304B can be the same sign or different signs, depending on the vehicle situation or intersection. In this example, the sign 304A indicates that the vehicle 12 is approaching a pedestrian crosswalk and the sign 304B indicates that the vehicle 12 intends to stop. In various embodiments, the controller 22 of the vehicle 12 determines which sign(s) to display based on data received from the variety of sensors 26 and the analysis of the sensor data by the ADS 24 and, if multiple signs are displayed, displays the signs next to each other.

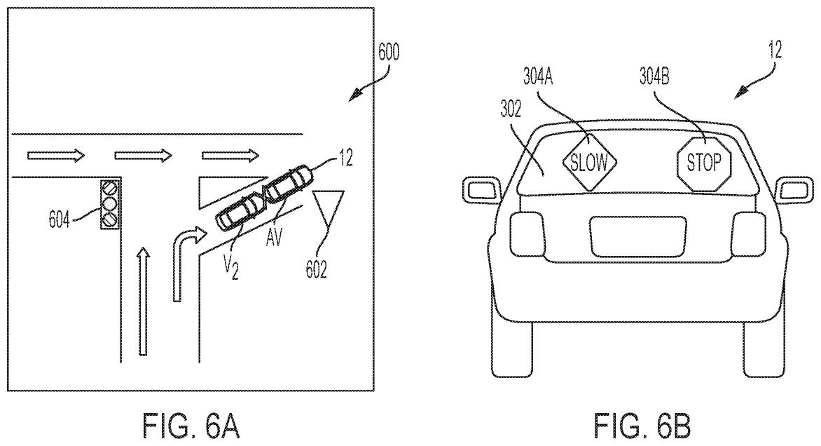

Another situational example is illustrated in FIGS. 6A and 6B. As shown in FIG. 6A, an autonomous or semi-autonomous vehicle, such as the vehicle 12, approaches a merging intersection 600. The intersection 600 includes a yield indicator 602 and also a traffic light 604. One or more vehicles, such as the vehicle V2, is in the vicinity of the vehicle 12, such as following behind the vehicle 12. The vehicle V2 may be an operator-controlled vehicle and the vehicle operator may not know the traffic flow at the intersection 600 or may not be able to predict the behavior of the vehicle 12.

As shown in FIG. 6B, the windshield 302 of the vehicle 12 includes technology capable of displaying one or more indication symbols, such as the indication symbols 304A, 304B. The indication symbols 304A, 304B can be the same sign or different signs, depending on the vehicle situation or intersection. In this example, the sign 304A indicates that the vehicle 12 is slowing for the yield and merge intersection and the sign 304B indicates that the vehicle 12 intends to stop. In various embodiments, the controller 22 of the vehicle 12 determines which sign(s) to display based on data received from the variety of sensors 26 and the analysis of the sensor data by the ADS 24.

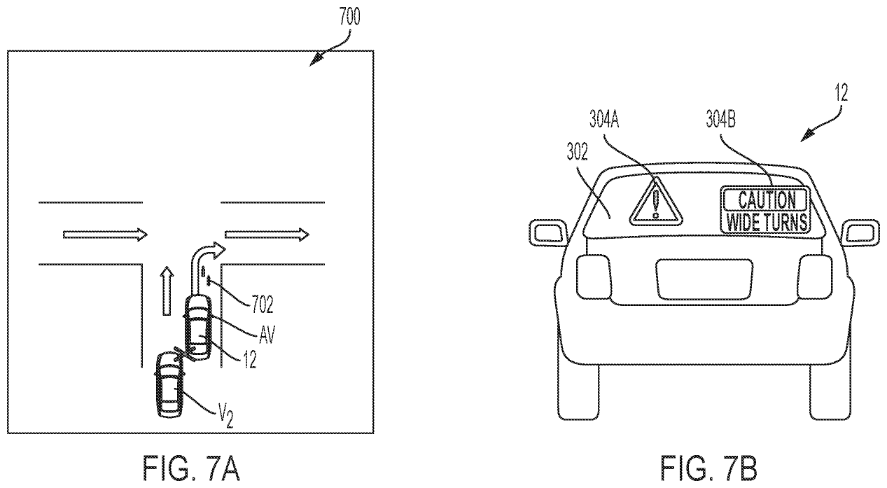

Yet another situational example is illustrated in FIGS. 7A and 7B. As shown in FIG. 7A, an autonomous or semi-autonomous vehicle, such as the vehicle 12, approaches an intersection 700. The intersection 700 includes one or more obstructions 702. One or more vehicles, such as the vehicle V2, is in the vicinity of the vehicle 12, such as following behind and/or in a blind spot of the vehicle 12. The vehicle V2 may be an operator-controlled vehicle and the vehicle operator may not see the obstruction 702 at the intersection 700 and thus might not be able to predict the behavior of the vehicle 12.

As shown in FIG. 7B, the windshield 302 of the vehicle 12 includes technology capable of displaying one or more indication symbols, such as the indication symbols 304A, 304B. The indication symbols 304A, 304B can be the same sign or different signs, depending on the vehicle situation or intersection. In this example, the sign 304A indicates general caution and is meant to alert the operator-controlled vehicle V2 that the vehicle 12 intends to perform a maneuver that may not be expected. The sign 304B indicates that the vehicle 12 intends to make a wide turn to avoid the obstruction 702. In various embodiments, the controller 22 of the vehicle 12 determines which sign(s) to display based on data received from the variety of sensors 26 and the analysis of the sensor data by the ADS 24.

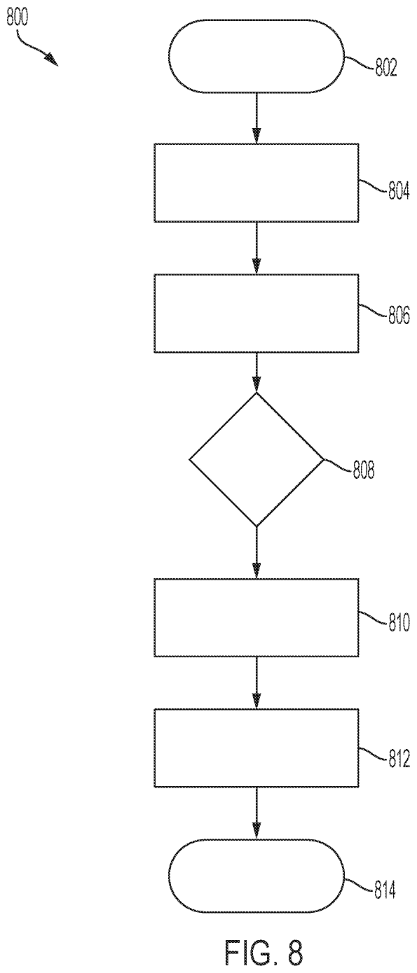

FIG. 8 illustrates a method 800 to visually communicate an intended vehicle maneuver, according to an embodiment. The method 800 can be utilized in connection with the vehicle 12 and the controller 22, ADS 24, and intention display system 18 as discussed herein, or by other systems associated with or separate from the vehicle, in accordance with exemplary embodiments. The order of operation of the method 800 is not limited to the sequential execution as illustrated in FIG. 8, but may be performed in one or more varying orders, or steps may be performed simultaneously, as applicable in accordance with the present disclosure.

Beginning at 802, the method 800 proceeds to 804. At 804, the perception system 32 of the ADS 24 determines the presence, location, classification, and path of detected features or objects in the vicinity of the vehicle 12. The localization and mapping module 40 uses the object classification and segmentation output 37 to calculate parameters including, but not limited to, estimates of the position and orientation of the vehicle 12 in both typical and challenging driving scenarios. The localization and mapping module 40 also incorporates any data received from an external source (such as the remote access center) to determine an intended or projected vehicle maneuver.

From 804, the method 800 proceeds to 806. At 806, the controller 22 correlates various vehicle maneuvers with understood indicators, such as signs, to achieve a sign-sentence mapping with the projected vehicle maneuver. In various embodiments, the sign-sentence to vehicle maneuver mapping is performed externally (such as by a remote computer or remote access center) and is transmitted to the vehicle 12 via the wireless communication system 28. In various embodiments, the sign-sentence to vehicle maneuver mapping is stored on a database accessible to the controller 22.

Next, at 808, the controller 22 determines whether the intended or projected maneuver of the vehicle 12 is associated or mapped with a corresponding sign-sentence. In various embodiments, the controller 22 determines whether the intended maneuver involves vehicle action, such as slowing, stopping, turning widely, etc., that may not be expected by the operators of surrounding vehicles. Mapping the intended or projected maneuver of the vehicle 12 with a corresponding sign-sentence includes, in some embodiments, evaluating a data set including a description of the intended vehicle maneuver. The description corresponds to one or more indication symbols, such as the indication symbols 304A, 304B.

In various embodiments, the data set is obtained from evaluation of responses of vehicle operators to various indication symbols or sign-sentences, the responses including the vehicle operators' perceived meaning of the sign-sentence. Each response in the data set is clustered to determine the generalized response to each sign-sentence. Using spectral clustering techniques, clusters having a density greater than a given threshold are identified. These clusters are then identified with a specific “human-readable explanation” that is associated with a specific set of indication symbols. The evaluation of the data set is performed, in some embodiments, within the controller 22, or within a controller exterior to the vehicle 12.

If the determination at 808 is positive, that is, that the vehicle maneuver has a corresponding sign-sentence or is a maneuver that should be communicated to surrounding vehicles, the method 800 proceeds to 810. At 810, the controller 22 generates an instruction to convey the intended vehicle maneuver to surrounding vehicles.

Next, at 812, the intention display system 18 of the controller 22 displays one or more signs conveying the intended or projected maneuver of the vehicle 12 such that the operators of surrounding vehicles are informed of the intended maneuver and can react accordingly. As discussed herein, the one or more signs may be displayed on a vehicle windshield, such as the rear windshield 302, or may be displayed in the brake/signal light systems 401.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A system for conveying an intended vehicle maneuver, comprising:
an intention display system including a controller configured to receive data regarding the presence, location, classification, and path of detected features in a vicinity of an automotive vehicle, determine the intended vehicle maneuver from the data regarding the detected features, map the intended vehicle maneuver to an indication symbol, and generate a control signal to display the indication symbol; and
a vehicle component of the automotive vehicle configured to display the indication symbol on the automotive vehicle such that the intended vehicle maneuver is communicated to surrounding vehicles;
wherein the vehicle component is a brake and signal light system of the automotive vehicle.

2. The system of claim 1, wherein the indication symbol is a traffic sign.

3. The system of claim 2, wherein the traffic sign includes one or more of the signs recognized by the Vienna Convention on Road Signs and Signals.

4. The system of claim 1, wherein the vehicle component is a rear windshield of a vehicle.

5. (canceled)

6. The system of claim 1 further comprising a wireless communication system in electronic communication with the controller, the wireless communication system configured to receive vehicle maneuver and indication symbol mapping data from a remote access center.

7. The system of claim 1 further comprising a projection system configured to project the indication symbol of the intended vehicle maneuver on the vehicle component, wherein the vehicle component is a rear windshield.

8. The system of claim 1, wherein the indication symbol includes a first indication symbol and a second indication symbol, and the first indication symbol is different from the second indication symbol.

9. The system of claim 8 further comprising a projection system configured to project the first and second indication symbols on a rear windshield of the automotive vehicle, wherein the first and second indication symbols are projected next to each other.

10. The system of claim 8, wherein the vehicle component includes a first brake and signal light system and a second brake and signal light system, and wherein the first indication symbol is displayed on the first brake and signal light system and the second indication symbol is displayed on the second brake and signal light system.

11. An automotive vehicle, comprising:
a wireless communication system configured to transmit and receive vehicle data;
a first actuator configured to control acceleration and braking of the automotive vehicle;
a second actuator configured to control steering of the automotive vehicle;
a vehicle sensor configured to generate data regarding the presence, location, classification, and path of detected features in a vicinity of the automotive vehicle; and
a brake and signal light system;
a controller in communication with the vehicle sensor, the first and second actuators, the brake and signal light system, and the wireless communication system, the controller configured to selectively control the first and second actuators in an autonomous mode along a first trajectory according to an automated driving system, the controller configured to
receive the data from the vehicle sensor regarding the presence, location, classification, and path of detected features in a vicinity of the automotive vehicle;
determine a predicted vehicle maneuver from the data regarding the detected features;
map the predicted vehicle maneuver with an indication symbol; and
generate a control signal to display the indication symbol on the brake and signal light system such that the predicted vehicle maneuver is communicated to surrounding vehicles.

12. The automotive vehicle of claim 11, wherein the indication symbol is a traffic sign.

13. The automotive vehicle of claim 12, wherein the traffic sign includes one or more of the signs recognized by the Vienna Convention on Road Signs and Signals.

14. The automotive vehicle of claim 11 further comprising a windshield configured to display the indication symbol.

15. (canceled)

16. The automotive vehicle of claim 11, wherein the wireless communication system is configured to receive vehicle maneuver and indication symbol mapping data from a remote access center.

17. The automotive vehicle of claim 11 further comprising a vehicle component and a projection system in communication with the controller, the projection system configured to project the indication symbol of the predicted vehicle maneuver on the vehicle component, wherein the vehicle component is a rear windshield.

18. The automotive vehicle of claim 17, wherein the indication symbol includes a first indication symbol and a second indication symbol, and the projection system is configured to project the first and second indication symbols next to each other on the rear windshield of the automotive vehicle.

19. The automotive vehicle of claim 11 further comprising a first brake and signal light system and a second brake and signal light system and wherein the indication symbol includes a first indication symbol and a second indication symbol such that the first indication symbol is displayed on the first brake and signal light system and the second indication symbol is displayed on the second brake and signal light system.

20. A method for communicating an intended vehicle maneuver of a vehicle having a brake and signal light system, the method comprising:
receiving, by a controller, data regarding the presence, location, classification, and path of detected features in a vicinity of the automotive vehicle;
determining, by the controller, the intended vehicle maneuver from the data regarding the detected features;
mapping, by the controller, the intended vehicle maneuver with one or more indication symbols, the mapping comprising evaluating a data set including a description of the intended vehicle maneuver, the description corresponding to one or more indication symbols; and
generating, by the controller, a control signal to display the one or more indication symbols on the brake and signal light system of the vehicle such that the intended vehicle maneuver is communicated to surrounding vehicles.
